(19) United States
(12) Patent Application Publication
(10) Pub. No.: US 2023/0117398 A1
(43) Pub. Date: Apr. 20, 2023

(54) PERSON RE-IDENTIFICATION METHOD USING ARTIFICIAL NEURAL NETWORK AND COMPUTING APPARATUS FOR PERFORMING THE SAME

(71) Applicant: ALCHERA INC., Seongnam-si (KR)

(72) Inventors: Jungho SON, Seoul (KR); Sangil JO, Icheon-si (KR); Yongjun SONG, Hwaseong-si (KR)

(73) Assignee: ALCHERA INC., Seongnam-si (KR)

(21) Appl. No.: 17/456,489

(22) Filed: Nov. 24, 2021

(30) Foreign Application Priority Data
Oct. 15, 2021 (KR) 10-2021-0137885

(51) Int. Cl. G06V 40/16; G06V 20/52

(52) U.S. Cl. CPC G06V 40/173; G06V 40/171; G06V 20/53

(57) ABSTRACT

Disclosed herein is a person re-identification method of identifying the same person from images taken through a plurality of cameras. The person re-identification method includes: detecting a person from an image taken by any one of a plurality of cameras; extracting bodily and movement path features of the detected person, and also extracting a facial feature of the detected person if the detection of the face of the detected person is possible; and matching the detected person for the same person against persons included in images taken by the plurality of cameras based on at least one of the bodily and facial features while reflecting a weight according to the movement path feature.

### CROSS-REFERENCE TO RELATED APPLICATION

This application claims the benefit of Korean Patent Application No. 10-2021-0137885 filed on Oct. 15, 2021, which is hereby incorporated by reference herein in its entirety.

### BACKGROUND

### 1. Technical Field

The embodiments disclosed herein relate to a method of re-identifying the same person from a plurality of images taken at different places, and an apparatus for performing the same.

This work was supported by A.I Recognition&Tracking System Project through the National IT Industry Promotion Agency(NIPA, Korea) funded by the Ministry of Science(MSIT, Korea) Informatization Promotion Funds in 2021.

### 2. Description of the Related Art

Person re-identification technology is a technology that detects and tracks the same person from images taken by a plurality of different cameras. Person re-identification technology is widely used not only in the field of security control but also in the process of tracking persons who have come into contact with an infected person in a public place used by many unspecified persons due to the recent COVID-19.

However, when re-identification is performed based on bodily features, the performance of the extraction of bodily features decreases as a photographing environment changes, and persons with similar bodily features may be present, so that there is a high possibility of error. Although accuracy may be improved when re-identification is performed based on facial features, there is still a limitation in terms of accuracy because a situation in which a face cannot be recognized occurs depending on a photographing angle.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

The embodiments disclosed herein are intended to provide a method of re-identifying the same person from a plurality of images taken at different places, and an apparatus for performing the method.

As a technical solution for accomplishing the above object, according to one embodiment, there is provided a person re-identification method of identifying the same person from images taken through a plurality of cameras, the person re-identification method including: detecting a person from an image taken by any one of a plurality of cameras; extracting bodily and movement path features of the detected person, and also extracting a facial feature of the detected person if the detection of the face of the detected person is possible; and matching the detected person for the same person against persons included in images taken by the plurality of cameras based on at least one of the bodily and facial features while reflecting a weight according to the movement path feature.

According to another embodiment, there is provided a computer program stored in a computer-readable storage medium to perform a person re-identification method of identifying the same person from images taken through a plurality of cameras in combination with a computer, which is hardware, wherein the method includes: detecting a person from an image taken by any one of a plurality of cameras; extracting bodily and movement path features of the detected person, and also extracting a facial feature of the detected person if the detection of the face of the detected person is possible; and matching the detected person for the same person against persons included in images taken by the plurality of cameras based on at least one of the bodily and facial features while reflecting a weight according to the movement path feature.

According to still another embodiment, there is provided a non-transitory computer-readable storage medium having stored thereon a computer program that, when executed by a computer, causes the computer to execute a person re-identification method of identifying the same person from images taken through a plurality of cameras therein, wherein the method includes: detecting a person from an image taken by any one of a plurality of cameras; extracting bodily and movement path features of the detected person, and also extracting a facial feature of the detected person if the detection of the face of the detected person is possible; and matching the detected person for the same person against persons included in images taken by the plurality of cameras based on at least one of the bodily and facial features while reflecting a weight according to the movement path feature.

According to still another embodiment, there is provided a computing apparatus for performing a person re-identification method of identifying the same person from images taken via a plurality of cameras, the computing apparatus including: an input/output interface configured to receive images from a plurality of cameras, and to output a result of person re-identification; storage configured to store a program for performing person re-identification; and a controller comprising at least one processor; wherein the controller, by executing the program, detects a person from an image taken by any one of the plurality of cameras, extracts bodily and movement path features of the detected person and also extracts a facial feature of the detected person if the detection of the face of the detected person is possible, and matches the detected person for the same person against persons included in images taken by the plurality of cameras based on at least one of the bodily and facial features while reflecting a weight according to the movement path feature.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating a movement path feature used in a person re-identification method according to an embodiment;

FIG. 2 is a view illustrating a method of obtaining a probability density function (PDF) for extracting a movement path feature according to an embodiment;

FIG. 3 is a diagram showing the configuration of a computing apparatus for performing a person re-identification method according to an embodiment;

FIG. 4 is a diagram illustrating an artificial neural network model implemented when a computing apparatus according to an embodiment performs a person re-identification method;

FIG. 5 is a view illustrating a method of detecting a person region from an image in the process of performing a person re-identification method according to an embodiment;

FIG. 6 is a view illustrating a method of performing same-person matching based on bodily and movement distance features in the process of performing a person re-identification method according to an embodiment; and

FIGS. 7 to 9 are flowcharts illustrating a person re-identification method according to embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component disposed therebetween.” Furthermore, when one portion is described as “including” one component, this does not mean that the portion does not exclude another component but means that the portion may further include another component, unless explicitly described to the contrary.

Embodiments of the present invention will be described in detail below with reference to the accompanying drawings.

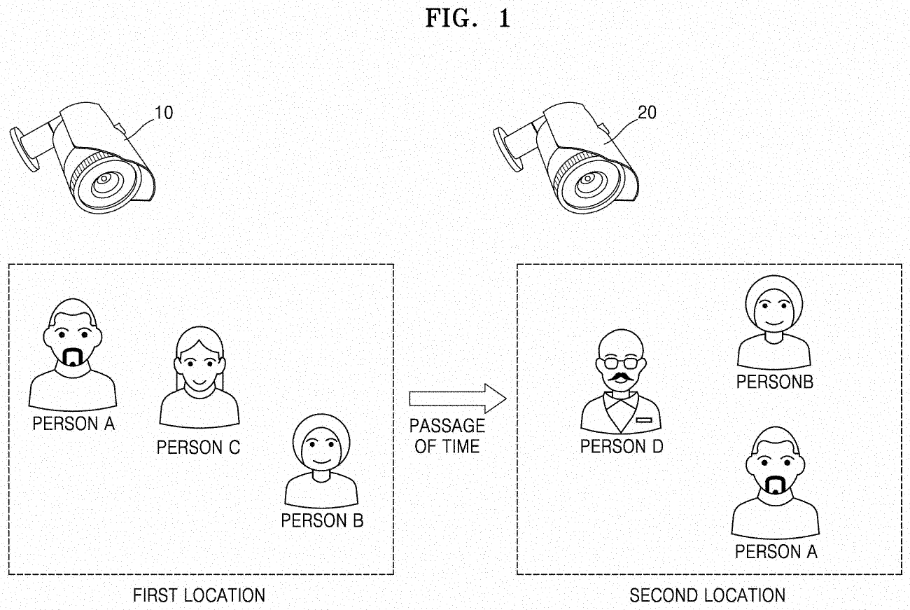

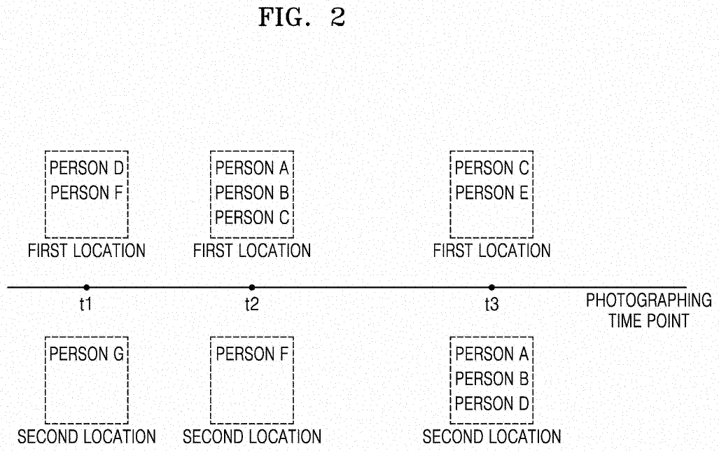

In this specification, there are introduced embodiments of a person re-identification method for identifying the same person from images taken by different cameras. In particular, in order to improve identification accuracy, the concept of a “movement path feature” is introduced for the first time, and is used in the process of performing person re-identification. Accordingly, before describing the embodiments of a person re-identification method, the concept of a “movement path feature” will be first described with reference to FIGS. 1 and 2.

First, the term “movement path feature” is defined as a probability value corresponding to the time taken to move along a specific path. In greater detail, the “movement path feature” is a probability value corresponding to the movement time of a specific person obtained according to a probability density function for the times (movement times) taken for a plurality of persons to move along a specific path.

A method of obtaining a probability density function used for the extraction of a movement time feature will be described in detail below.

FIG. 1 is a view illustrating a movement path feature used in a person re-identification method according to an embodiment.

It is assumed that a first camera 10 and a second camera 20 shown in FIG. 1 have different photographing locations and both the cameras 10 and 20 are connected to the same server. CCTV cameras installed at a specific distance on a street may be thought of as an example of the first and second cameras. For convenience of description, the location at which the first camera 10 takes an image is referred to as a “first location,” and the location at which the second camera 20 takes an image is referred to as a “second location.”

Referring to FIG. 1, an image taken by the first camera 10 at the first location at a specific time point includes person A, person B, and person C. In addition, an image taken by the second camera 20 at the second location after a predetermined time has elapsed from the specific time point includes person A, person B, and person D.

In order to calculate the times taken for persons to move from the first location to the second location, the same person needs to be identified from among the persons included in the images taken at the two locations. The server connected to the two cameras 10 and 20 may extract facial features of the persons included in the images taken at the first and second locations by analyzing the images, and may identify the same person from the two images by comparing the extracted facial features. In the process of obtaining a probability density function for movement times, the accurate identification of the same person is required, so that only persons whose facial features can be extracted may be taken into consideration.

The server connected to the two cameras 10 and 20 may obtain a movement time between the first and second locations for persons who are determined to be the same persons. The server may determine that the difference between the time point at which person A appears in the image taken at the second location and the time point at which person A appears in the image taken at the first location is the movement time of person A. In addition, in a similar manner, the server may determine that the difference between the time point at which person B appears in the image taken at the second location and the time point at which person B appears in the image taken at the first location is the movement time of person B.

The server may calculate and distribute the movement times of a large number of persons for various paths by utilizing the identification numbers and photographing times of cameras, and may then obtain a probability density function for movement times by using distributed results. A method of collecting the moving times of persons for a specific path and obtaining a probability density function for the moving times will be described in detail with reference to FIG. 2.

FIG. 2 is a view illustrating a method of obtaining a probability density function (PDF) for extracting a movement path feature according to an embodiment.

Referring to FIG. 2, persons included in images taken at first and second locations are shown while the photographing time progresses from t1 through t2 to t3.

In FIG. 2, the time taken for each person to move from the first position to the second position is as follows (in the case of persons C and E, the movement times cannot be known only from the data presented in FIG. 2):

Person A: t3−t2

Person B: t3−t2

Person D: t3−t1

Person F: t2−t1

After calculating movement times for a large number of persons in this manner, the server may check the frequency for each movement time, may generate a histogram showing the frequency distribution, and may obtain a probability density function from the generated histogram.

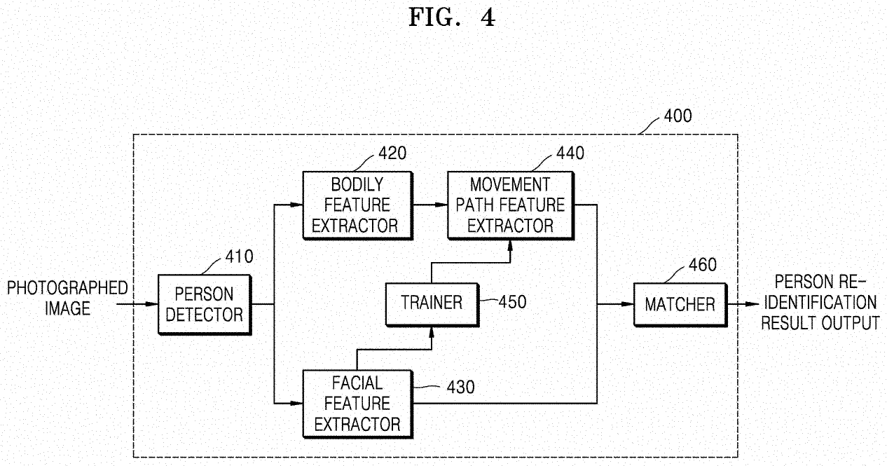

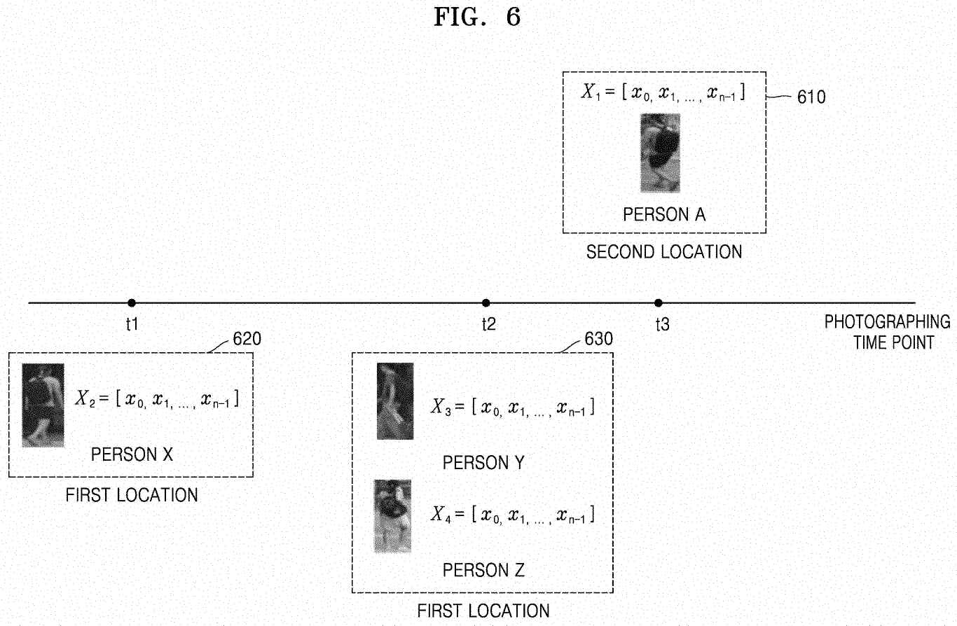

The probability density function obtained according to the process described above may be used to extract a movement path feature. This will be described in detail with reference to FIG. 6 below. Furthermore, in the process of performing a person re-identification method according to an embodiment, the server may continuously calculate a movement time for each person and update a probability density function for movement times by reflecting a calculation result, thereby increasing accuracy. This is referred to as training a “movement path feature extractor,” and will be described with reference to FIGS. 4 to 9 below.

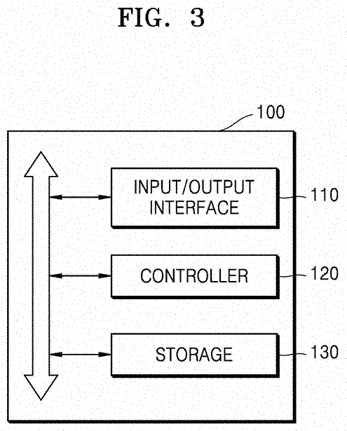

FIG. 3 is a diagram showing the configuration of a computing apparatus for performing a person re-identification method according to an embodiment. In the foregoing description, the two cameras 10 and 20 of FIG. 1 have been described as being connected to one server. In this case, the server may be the computing apparatus of FIG. 3.

Referring to FIG. 3, the computing apparatus 100 may include an input/output interface 110, a controller 120, and storage 130.

The input/output interface 110 is a component for the input/output of data and commands. The input/output interface 110 may receive images from a plurality of cameras, and may display results obtained by performing person re-identification on the images or transmit the results to another apparatus. Furthermore, the input/output interface 110 may receive a command related to the performance of person re-identification, etc. from a user. The input/output interface 110 may include a component for receiving input such as a keyboard, hard buttons, or a touch screen, a component for performing output such as an LCD panel, and a component for performing input/output such as a wired/wireless communication port.

The controller 120 is a component including at least one processor such as a central processing unit (CPU), and controls the overall operation of the computing apparatus 100. In particular, the controller 120 may implement an artificial neural network model for performing person re-identification by executing a program stored in the storage 130 to be described later. A specific method by which the controller 120 generates an artificial neural network model for performing person re-identification and performs person re-identification using the artificial neural network model will be described in detail below.

The storage 130 is a component for storing data and a program, and may include at least one of various types of memory such as RAM, HDD, and SSD. A program for implementing an artificial neural network model for performing person re-identification may be stored in the storage 130.

A method of performing person re-identification according to an embodiment will be described in detail with reference to FIGS. 4 to 9 below.

FIG. 4 is a diagram illustrating an artificial neural network model (a software component) implemented when a computing apparatus according to an embodiment performs a person re-identification method.

As described above, the controller 120 of the computing apparatus 100 shown in FIG. 3 may generate the artificial neural network model 400 shown in FIG. 4 by executing the program stored in the storage 130. Accordingly, the operations described below as being performed by the artificial neural network model 400 or detailed components included in the artificial neural network model 400 are actually performed by the controller 120.

Referring to FIG. 4, the artificial neural network model 400 for performing person re-identification may include a person detector 410, a bodily feature extractor 420, a facial feature extractor 430, a movement path feature extractor 440, a trainer 450, and a matcher 460.

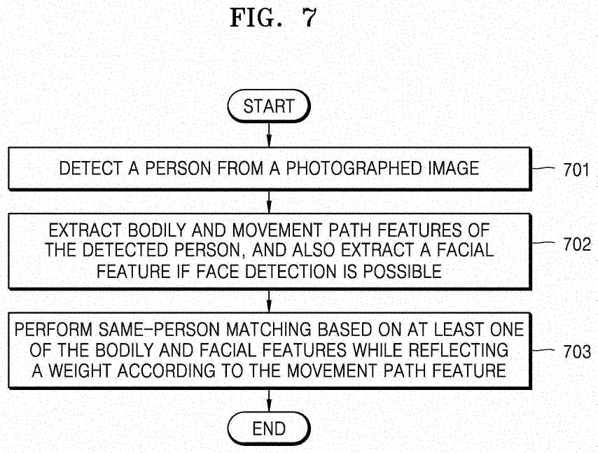

The operations of the respective modules will be described with reference to the flowcharts of FIGS. 7 to 9. FIGS. 7 to 9 are flowcharts illustrating a person re-identification method according to embodiments.

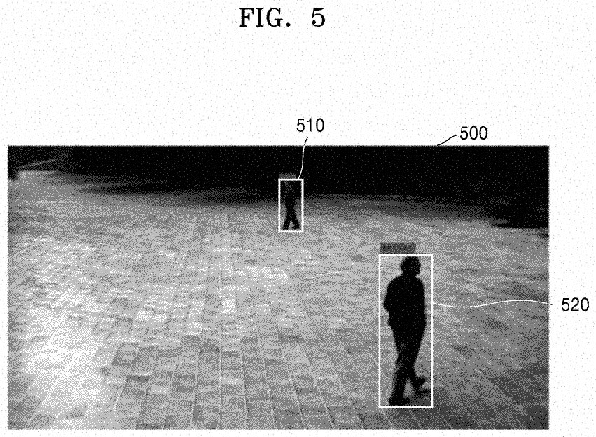

Referring to FIG. 7, at step 701, the person detector 410 detects a person from an image. A method of detecting a person from an image will now be described in greater detail with reference to FIG. 5. The image 500 shown in FIG. 5 includes two persons. When the person detector 410 receives the image 500, it detects bounding boxes 510 and 520 surrounding the two respective persons as “person regions.” Images of the person regions 510 and 520 detected in this manner become a query that is a target of re-identification, and are used to extract features (bodily, facial, and movement path features) at later steps.

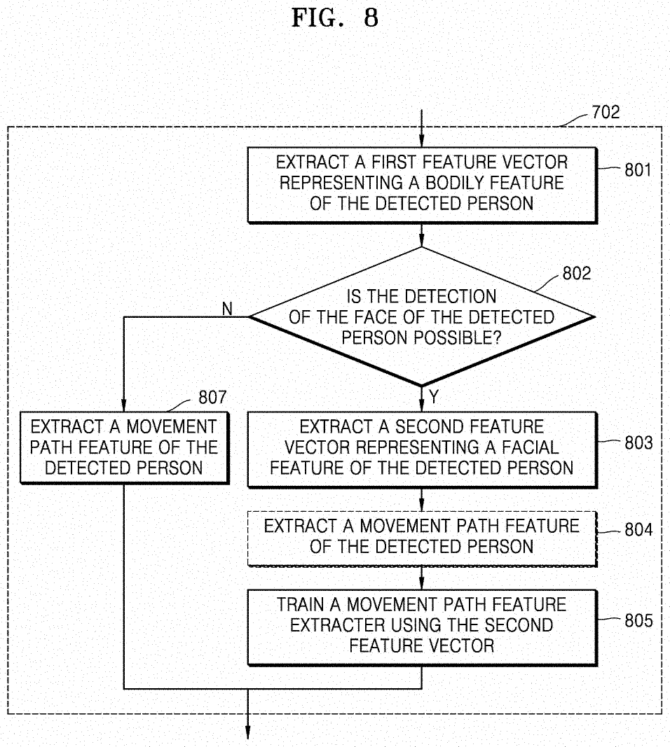

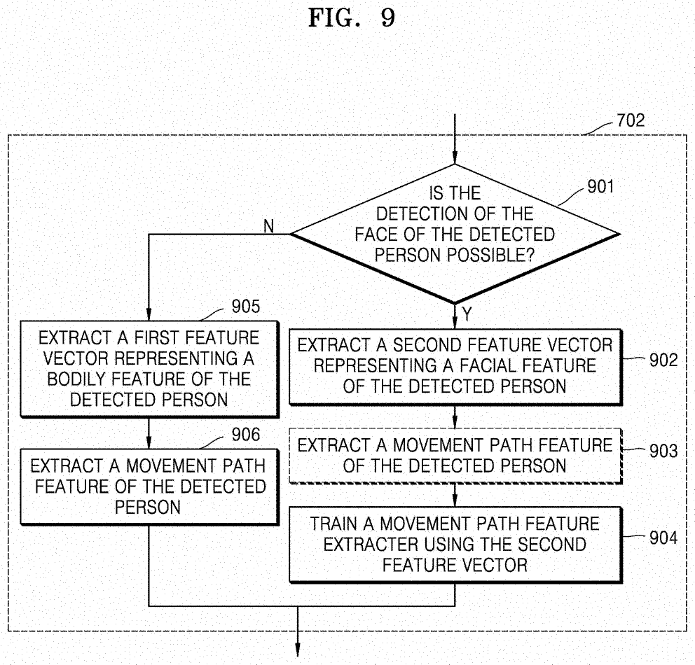

At step 702, the bodily feature extractor 420 may extract a bodily feature of each of the detected persons, the movement path feature extractor 440 may extract the movement path feature of each of the detected persons, and the facial feature extractor 430 may also extract a facial feature when the detection of the face of each of the detected persons is possible (e.g., when the face of the person detected from a screen corresponds to a predetermined proportion or more). Detailed steps included in step 702 may be configured in various manners, and in particular, may vary depending on whether a face can be detected, which will be described in detail with reference to FIGS. 8 and 9.

FIGS. 8 and 9 are flowcharts showing detailed steps included in step 702 of FIG. 7 according to different embodiments.

Referring to FIG. 8, at step 801, the bodily feature extractor 420 extracts a first feature vector representing a bodily feature from the person regions 510 and 520 detected at step 701. In this case, the extracted first feature vector may be used to calculate similarity with previously stored feature vectors at the step of matching the same persons later. To this end, feature vectors representing bodily features of persons detected from images previously taken by various cameras may be stored in a gallery (see step 703 to be described later).

At step 802, the facial feature extractor 430 determines whether face detection is possible from the person regions 510 and 520 detected at step 701. For example, the facial feature extractor 430 may determine that face detection is possible if a facial region visible from each of the detected person regions 510 and 520 corresponds to a predetermined proportion or more of a total facial region. Otherwise, the facial feature extractor 430 may determine that face detection is not possible.

If it is determined that face detection is possible, the process proceeds to step 803, at which the facial feature extractor 430 extracts a second feature vector representing a facial feature of each of the detected persons. In this case, the extracted second feature vector may be used in the process of identifying the same person and then training (updating the probability density function for movement times) the movement path feature extracter 430 later, and may also be used to calculate similarity with previously stored feature vectors at the step of matching the same persons. To this end, feature vectors representing facial features of persons detected from images previously taken by various cameras may also be stored in the gallery (see step 703 to be described later).

Step 804 is a step that may be selectively included as can be seen from the dotted line. At step 804, the movement path feature extractor 440 extracts a movement path feature of each of the detected persons. The reason that step 804 is a selectively inclusive step is that the identification of the same person based on a facial feature has a considerably high accuracy, so that once the second feature vector representing the facial feature has been extracted, there is no need to perform person re-identification by reflecting the movement path feature. However, even in the case where the facial feature is extracted, when the movement path feature is reflected, even a little higher re-identification accuracy can be expected, so that the process is configured to selectively include step 804.

At step 805, the trainer 450 trains the movement path feature extractor 440 using the second feature vector. Training the movement path feature extractor 440 refers to updating the probability density function for movement times. The method of obtaining a probability density function for movement times was discussed with reference to FIGS. 1 and 2 above. According to the method, the probability density function may be updated by adding a movement time sample for a specific distance through the identification of the same person using the second feature vector. The trainer 450 may increase re-identification accuracy by continuously updating the probability density function for movement times using a facial feature obtained in the process of performing person re-identification.

Although step 805 may be performed after step 804 as shown in FIG. 8, it may alternatively be performed after step 703 of FIG. 7.

If it is determined at step 802 that the detection of the face of each of the detected persons is not possible, the process proceeds to step 807, at which the movement path feature extractor 440 extracts a movement path feature of each of the detected persons. In this case, same-person matching may be performed at step 703 based on the first feature vector representing the bodily feature extracted at step 801 and the movement path feature.

Another embodiment of step 702 of FIG. 7 will now be described with reference to FIG. 9. When the embodiment of FIG. 8 and the embodiment of FIG. 9 are compared with each other, they are different in that in the embodiment of FIG. 8, a bodily feature is always extracted for re-identification, whereas in the embodiment of FIG. 9, a bodily feature is extracted only when face detection is not possible and re-identification is performed using only a facial feature when face detection is possible (even a movement path feature may be taken into consideration depending on user selection). Accordingly, since some steps included in FIG. 9 are substantially the same as their corresponding steps included in FIG. 8, detailed descriptions thereof will be omitted below.

Referring to FIG. 9, at step 901, the facial feature extractor 430 determines whether face detection is possible from the person regions 510 and 520 detected at step 701. A method of determining whether face detection is possible is the same as described above in conjunction with step 802.

If it is determined that face detection is possible, the process proceeds to step 902, at which the facial feature extractor 430 extracts a second feature vector representing a facial feature of each of the detected persons.

Step 903 is a step that may be selectively included like step 804 described above. At step 903, the movement path feature extractor 440 extracts a movement path feature of each of the detected persons.

At step 904, the trainer 450 trains the movement path feature extractor 440 using the second feature vector.

Although step 904 may be performed after step 903 as shown in FIG. 9, it may alternatively be performed after step 703 of FIG. 7.

If it is determined at step 901 that the detection of the face of each of the detected persons is not possible, the process proceeds to step 905, at which the bodily feature extractor 420 extracts a first feature vector representing a bodily feature of each of the detected persons.

At step 906, the movement path feature extractor 440 extracts a movement path feature of each of the detected persons.

Referring back to FIG. 7, once the extraction of the bodily feature, the movement path feature, and, if possible, the facial feature from each of the persons detected at step 702 has been completed according to the method described above, the process proceeds to step 703, at which the matcher 460 may perform same-person matching based on at least one of the bodily and facial features while reflecting a weight according to the movement path feature.

Depending on the types of features extracted at step 702, the method of performing same-person matching may vary slightly. A method of performing same-person matching based on bodily and movement path features will be described in detail with reference to FIG. 6 below. In FIG. 6, it is assumed that time passes from t1 to t3.

Referring to FIG. 6, a person region including person A included in the image 610 taken at time point t3 from the second location becomes a query, which is a re-identification target. The first feature vector extracted from person A by the bodily feature extractor 420 at step 801 is X₁=[x₀, x₁, . . . , xₙ₋₁].

Meanwhile, for person re-identification, features (bodily and facial features) of persons included in images taken by the same or a different camera at a previous time point are stored in advance in a database, and this database is referred to as a “gallery.”

In the embodiment shown in FIG. 6, a feature vector X₂=[x₀, x₁, . . . , xₙ₋₁] representing the bodily feature of person X included in the image 620 taken at time point t1 from the first location is stored in advance in the gallery. Similarly, a feature vector X₃=[x₀, x₁, . . . , xₙ₋₁] representing a bodily feature of person Y and a feature vector X₄=[x₀, x₁, . . . , xₙ₋₁] representing a bodily feature of person Z included in the image 630 taken at time point t2 from the first location are also stored in advance in the gallery.

The matcher 460 calculates similarities by comparing the feature vector representing the bodily feature of person A with the feature vectors representing the bodily features of persons X to Z stored in advance in the gallery one by one. A method of calculating similarities between feature vectors may be implemented in various manners, and one of them will be introduced as follows.

According to an embodiment, a similarity between two feature vectors may be calculated via cosine similarity. Each feature vector is expressed as one coordinate in a specific space. The similarity may be determined by calculating the angle between the two feature vectors. The cosine similarity is a method of determining the similarity based on the angle between two vectors in a dot product space. If the two vectors to be compared are A=[A₀, A₁, . . . , Aₙ₋₁] and B=[B₀, B₁, . . . , Bₙ₋₁], respectively, the cosine distance, which is the dot product value between the two vectors whose size is 1, may be calculated according to Equation 1 below, and the similarity may be determined according to the value of the calculated cosine distance. The cosine distance has a value between −1 and 1. The closer to 1, the higher the similarity.

$$\frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad ( 1 )$$

According to the method described above, the similarity is calculated by comparing the feature vector representing the bodily feature of person A with the feature vectors representing the bodily features of persons X to Z.

Now a method of reflecting a weight according to a movement path feature in a similarity between feature vectors will be described.

In FIG. 6, when person A and person X are compared with each other, the movement time becomes (t3−t1). When person A is compared with person Y and person Z, the movement times all become (t3−t2). The movement path feature extractor 440 extracts a probability value corresponding to each of the movement times calculated above by using a previously prepared probability density function for movement times. Then, the weight according to the extracted probability value is reflected in the similarity between the feature vectors. In this case, a method of reflecting a weight according to an extracted probability value in a similarity between feature vectors may be implemented in various manners in the direction in which as the probability value increases, a larger weight is allocated.

For example, according to the probability density function for movement times, when the probability value corresponding to the movement time (t3−t1) is 50% and the probability value corresponding to the movement time (t3−t2) is 10%, a weight according to 50% may be added or multiplied to the similarity between the feature vectors of person A and person X, and a weight according to 10% may be added or multiplied to the similarity between the feature vectors of person A and persons Y and Z.

The matcher 460 may determine whether there is a person who can be regarded as being the same as person A among persons X to Z based on the similarities in which the weights according to the movement time features are reflected through this process, may match persons determined to be the same persons, and may output the persons as a re-identification result.

In FIG. 6, a method of performing matching based on bodily and movement path features has been described. The similarity determination based on facial features may be performed in a similar manner. For example, even when the feature vectors shown in FIG. 6 are feature vectors representing facial features other than feature vectors representing bodily features, matching may be performed according to the method described above in conjunction with FIG. 6. Furthermore, for example, when both feature vectors representing bodily features and feature vectors representing facial features are prepared, similarities may be calculated for respective types of feature vectors, and matching may be performed based on results obtained by adding the result values.

As described above, the matcher 460 may perform matching varying depending on the types of features that are extracted at previous steps. More specifically, i) when bodily and movement path features are prepared, matching may be performed by reflecting weights according to movement path features in similarities between feature vectors representing bodily features, ii) when bodily and facial features are prepared, matching may be performed based on the similarities between feature vectors representing the respective features, iii) when bodily, facial, and movement path features are all prepared, matching may be performed based on the similarities between feature vectors representing respective features while reflecting weights according to movement path features therein, iv) when facial and movement path feature are prepared, matching may be performed by reflecting weights according to movement path features in similarities between feature vectors representing the facial features, and v) when only facial features are prepared, matching may be performed based on similarities between feature vectors representing the facial features.

According to the above-described embodiments, the effect of performing person re-identification with high accuracy even when a photographing environment changes or determination based only on appearance information is ambiguous may be expected by taking into consideration movement path features reflecting movement times between cameras.

Furthermore, the effect of increasing re-identification accuracy may be expected by continuously training the model for extracting movement path features through comparison between facial features.

The effects that can be obtained by the embodiments disclosed herein are not limited to the above-described effects, and other effects that have not been described above will be clearly understood by those having ordinary skill in the art, to which the present invention pertains, from the foregoing description.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and ‘unit(s)’ may be coupled to a smaller number of components and ‘unit(s)’ or divided into a larger number of components and ‘unit(s).’

In addition, components and ‘unit(s)’ may be implemented to run one or more CPUs in a device or secure multimedia card.

The person re-identification method according to the embodiments described in conjunction with FIGS. 4 to 9 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the person re-identification method according to the embodiments described in conjunction with FIGS. 4 to 9 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the person re-identification method according to the embodiments described in conjunction with FIGS. 4 to 9 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing apparatus. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing apparatus. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention.

What is claimed is:

1. A person re-identification method of identifying a same person from images taken through a plurality of cameras, the person re-identification method comprising:
detecting a person from an image taken by any one of a plurality of cameras;
extracting bodily and movement path features of the detected person, and also extracting a facial feature of the detected person if detection of a face of the detected person is possible; and
matching the detected person for a same person against persons included in images taken by the plurality of cameras based on at least one of the bodily and facial features while reflecting a weight according to the movement path feature.

2. The person re-identification method of claim 1, wherein the movement path feature is a probability value corresponding to a movement time of the detected person obtained according to a probability density function for movement times taken for a plurality of persons to move along a specific path.

3. The person re-identification method of claim 2, further comprising, if the facial feature of the detected person is also extracted, updating the probability density function by identifying the same person among persons included in the images taken by the plurality of cameras based on the facial feature, calculating movement times of the detected person for respective sections, and reflecting the calculated movements in the probability density function.

4. The person re-identification method of claim 1, wherein extracting the bodily and movement path features of the detected person and also extracting the facial feature of the detected person comprises:
extracting a first feature vector representing a bodily feature of the detected person;
determining whether the detection of the face of the detected person is possible; and
extracting a second feature vector representing a facial feature of the detected person if it is determined that the detection of the face is possible, and extracting a movement path feature of the detected person if it is determined that the detection of the face is not possible.

5. The person re-identification method of claim 1, wherein extracting the bodily and movement path features of the detected person and also extracting the facial feature of the detected person comprises:
determining whether the detection of the face of the detected person is possible; and
extracting a second feature vector representing a facial feature of the detected person if it is determined that the detection of the face is possible, and extracting a first feature vector representing a bodily feature of the detected person and a movement path feature of the detected person if it is determined that the detection of the face is not possible.

6. A non-transitory computer-readable storage medium having stored thereon a computer program that, when executed by a computer, causes the computer to execute the method of claim 1 therein.

7. A computer program stored in a computer-readable storage medium to perform the method of claim 1 in combination with a computer, which is hardware.

8. A computing apparatus for performing a person re-identification method of identifying a same person from images taken via a plurality of cameras, the computing apparatus comprising:
an input/output interface configured to receive images from a plurality of cameras, and to output a result of person re-identification;
storage configured to store a program for performing person re-identification; and
a controller comprising at least one processor;
wherein the controller, by executing the program, detects a person from an image taken by any one of the plurality of cameras, extracts bodily and movement path features of the detected person and also extracts a facial feature of the detected person if detection of a face of the detected person is possible, and matches the detected person for a same person against persons included in images taken by the plurality of cameras based on at least one of the bodily and facial features while reflecting a weight according to the movement path feature.

9. The computing apparatus of claim 8, wherein the movement path feature is a probability value corresponding to a movement time of the detected person obtained according to a probability density function for movement times taken for a plurality of persons to move along a specific path.

10. The computing apparatus of claim 9, wherein if the facial feature of the detected person is also extracted, the controller updates the probability density function by identifying the same person among persons included in the images taken by the plurality of cameras based on the facial feature, calculating movement times of the detected person for respective sections, and reflecting the calculated movements in the probability density function.

11. The computing apparatus of claim 8, wherein when extracting the bodily and movement path features of the detected person and also extracting the facial feature of the detected person, the controller extracts a first feature vector representing a bodily feature of the detected person, determines whether the detection of the face of the detected person is possible, and extracts a second feature vector representing a facial feature of the detected person if it is determined that the detection of the face is possible, and extracts a movement path feature of the detected person if it is determined that the detection of the face is not possible.

12. The computing apparatus of claim 8, wherein when extracting the bodily and movement path features of the detected person and also extracting the facial feature of the detected person, the controller determines whether the detection of the face of the detected person is possible, and extracts a second feature vector representing a facial feature of the detected person if it is determined that the detection of the face is possible, and extracts a first feature vector representing a bodily feature of the detected person and a movement path feature of the detected person if it is determined that the detection of the face is not possible.
